(19) United States
(12) Patent Application Publication
(10) Pub. No.: US 2005/0050239 A1
(43) Pub. Date: Mar. 3, 2005

(54) Output switching device, output switching program, output switching program storage medium and output switching method

(76) Inventor: Yoji Kimura, Tokorozawa (JP)

Correspondence Address: SWIDLER BERLIN SHEREFF FRIEDMAN, LLP, 3000 K STREET, NW, BOX IP, WASHINGTON, DC, 20007, US

(21) Appl. No.: 10/853,233

(22) Filed: May 26, 2004

(30) Foreign Application Priority Data
Sep. 2, 2003 (JP) 2003-310156

(51) Int. Cl. G06F 3/00

(52) U.S. Cl. 710/15

(57) ABSTRACT

An output switching device provides an output by selecting an output of a plurality of information apparatuses through operations of the same apparatus without addition of a control program or the like. The output switching device includes a detecting unit for detecting change in input mode of a plurality of information apparatuses, a selecting unit for selecting an input from the information apparatus in which change in input mode is detected with the detecting unit, a switching unit for selecting and switching an input of the information apparatus in which change in input mode is detected with the detecting unit, and an output unit for outputting an input selected with the selecting unit.

### BACKGROUND OF THE INVENTION

The present invention relates to an output switching device for providing an output by selecting an input from a plurality of information apparatuses.

In recent years, personal computers have been used more frequently to make announcements or presentations.

Accordingly, when presentations are made using a personal computer, a projector or the like is usually provided as a video output apparatus for the presenter. Whenever the presenter changes, the personal computer carried in the room by the presenter must be re-connected to the projector or the like.

Therefore, an output switching device has been used to change over the personal computer with the goal of eliminating troublesome procedures such as re-connection to the projector or the like.

FIG. 1 illustrates an example of an output switching device of the prior art. In FIG. 1, a personal computer is used as the information apparatus and a projector is used as a video output apparatus. The output switching device selects the video signal of personal computers and provides an output to the projector.

The output switching apparatus 24 is connected with three units of personal computers 2, 3, 4 and a projector 5. The output switching device 24 is also provided with an output change-over switch 23.

Each personal computer is connected with keyboard 6, 7, 8 for input operation via a keyboard input terminal 9. Each video output terminal 11 of the personal computer 2, 3, 4 is connected with a video input terminal 12 of the output switching device 24.

The output switching device 24 includes a selected video output terminal 21, which is connected with a video input terminal 22 of the projector 5.

An output switching system as described above outputs any video signal outputted from the selected personal computer 2, 3, 4 selected with the information change-over switch 23.

As another output switching means, a control cable only for switching of output is provided between each personal computer and the output switching device. In this switching means, the video signal of personal computer is switched through the operation of the personal computer.

In the conventional apparatus, an output switching device has been installed when a personal computer is used for announcement or presentation and thereby an output from the personal computer has been outputted to a display such as projector 5 or the like through the switching thereof.

Troublesome procedures such as re-connection of personal computer to the projector whenever a presenter changes can be eliminated when a personal computer is used for announcement or presentation by introducing the output switching device described above.

Moreover, since the projector and personal computer are not required to repeatedly connect and disconnect the power supply, wear and tear of the contacts of the connectors can also be eliminated.

In addition, there is another output switching device, described on the Internet as “CPU Switch”, at URL:http://www.arvel.co.jp/equip/chg/usbcpu/acscpu2h6.html. The output switching device described therein includes a set which includes a keyboard, a display, and mouse which is used to operate a plurality of personal computers. The relevant output switching device has a structure which may be connected with a plurality of personal computers, and may be connected with a display for outputting the video signal from the personal computer, and a keyboard and a mouse for operating the personal computer.

The output change-over switch provided on the output switching device or the particular key on the keyboard is capable of switching the personal computer.

However, in the switching device for switching the outputs with a switch, where the output change-over switch is provided on the output switching device, the switching operation by operation from each personal computer has been impossible.

Accordingly, for systems where the output switching device is separated from a personal computer, it has been required to repeatedly send persons to operate the output switching device isolated from the personal computer in view of outputting the video signal by selecting a particular personal computer.

Even when an exclusive control cable only for the switching of output is connected to each personal computer to realize the switching operation from the place where the personal computer is provided, a control program for controlling the switching of output has also been required for the personal computer.

### SUMMARY OF THE INVENTION

The present invention provides an output switching device which can select an input from a plurality of outputs and provide an output with operation of the information apparatus without addition of a control program or the like.

The present invention includes an output switching device for selecting an input from a plurality of information apparatuses, and then providing an output. For this purpose, the output switching device of the present invention includes a detecting unit for detecting change in each input mode of a plurality of information apparatuses, a selecting unit for selecting an input from the information apparatus for which change in input mode is detected with the detecting unit, a switching unit for selecting and switching an input of the information apparatus for which change in input mode is detected with the detecting unit and an output unit for outputting the input selected with the selecting unit.

Moreover, the present invention provides an output switching device for providing an output by selecting an input from a plurality of information apparatuses and is characterized in switching to an output of the information apparatus in which an input mode is changed in the detecting unit and inhibiting the switching to the other information apparatus when the input mode is changed to the other mode in the information apparatus.

The present invention further relates to an output switching device providing an output by selecting an input from a plurality of information apparatuses and is characterized in that the detecting unit for detecting the information apparatus in which the input mode is changed for a plurality of times and the selecting unit selects the output of the information apparatus in which change is detected for a plurality of times with the detecting unit.

The present invention further relates to an output switching program for providing an output by selecting an input from a plurality of information apparatuses and is characterized in controlling such output switching program to execute a detection step for detecting change in each input mode of a plurality of information apparatuses and a selecting step for selecting an input from the information apparatus in which change in the input mode is detected with the detecting unit.

The present invention further relates to a computer-readable storage medium storing the output switching program for providing an output by selecting an input of a plurality of information apparatuses and is characterized in controlling such output switching program to execute the detecting step for detecting change in each input mode of a plurality of information apparatuses and the selecting step for selecting an input from the information apparatus in which change in the input mode is detected with the detecting unit.

Moreover, the present invention further includes an output switching method for providing an output by selecting an input from a plurality of information apparatuses and is characterized in detecting a plurality of information apparatuses, notifying the information apparatus in which the input mode is changed, and selecting and switching an output of the information apparatus notified during the switching of the information apparatus for providing an output by switching an output of a plurality of information apparatuses.

As described above, according to the present invention, since the switching control of the information apparatus is performed when change in the input mode of the information apparatus is detected, a control program is not required unlike the prior art. Also, the switching control of the information apparatus can be performed without any direct operation of the output switching device.

### BRIEF DESCRIPTION OF THE DRAWINGS

FIG. 1 is a block diagram of a known output switching device;

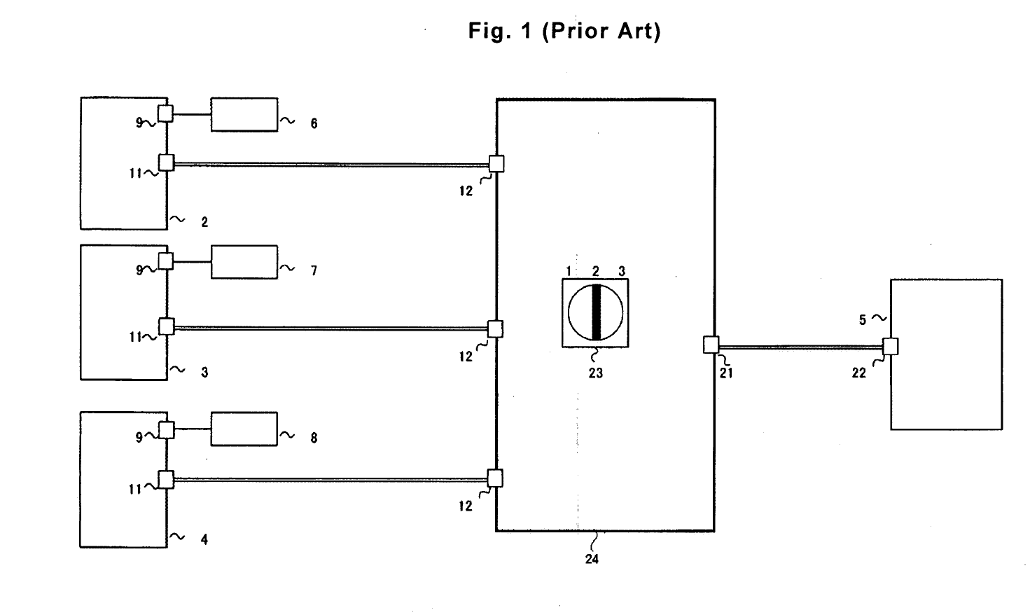

FIG. 2 is a block diagram of an output switching device according to an embodiment of the present invention;

FIG. 3 illustrates reception of a status signal of the keyboard;

FIG. 4 is a flowchart of a status signal detection program according to one embodiment of the present invention;

FIG. 5 is a flowchart of a switching control program according to one embodiment of the present invention;

### DETAILED DESCRIPTION OF THE PREFERRED EMBODIMENTS

A preferred embodiment of the present invention will be described with reference to the accompanying drawings.

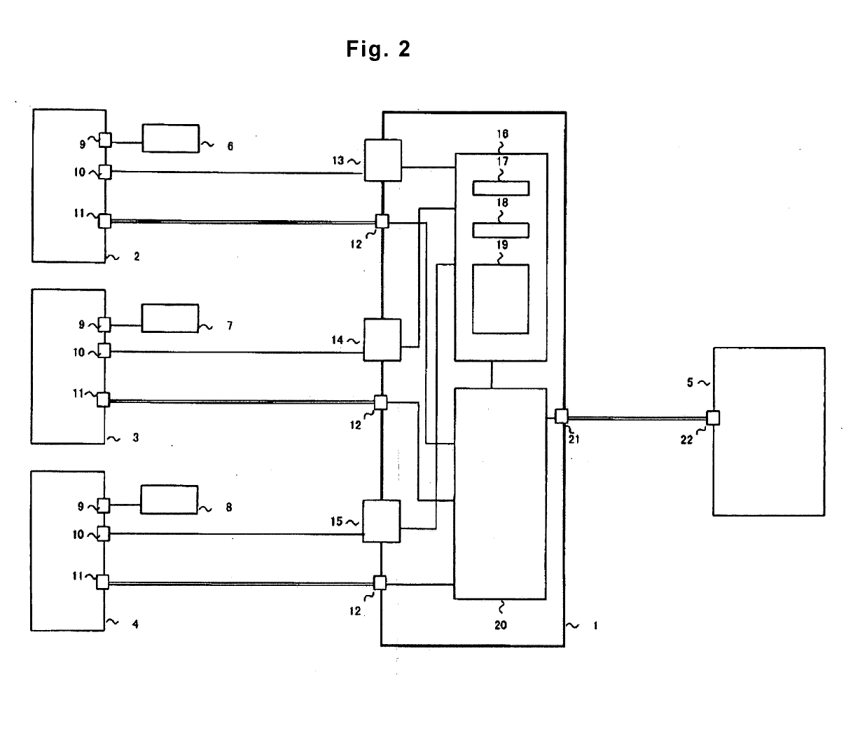

FIG. 2 is a block diagram of an output switching system according to a preferred embodiment of the present invention. An output switching device 1 includes status signal detecting units 13, 14, 15, a switching control unit 16, a video signal selecting unit 20, a video input terminal 12, and a selected video output terminal 21. The switching control unit 16 includes a program storage unit 17, a program processing unit 18 and a switching storage unit 19. The video input terminal 12 and selected video output terminal 21 use a D-sub terminal or DVI terminal.

Personal computers 2, 3, 4 are respectively provided with a keyboard input terminal 9, an external keyboard input terminal 10 and a video output terminal 11. The keyboard input terminal 9 and external keyboard input terminal 10 can use, for example, a, PS/2 terminal or USB terminal. Each keyboard input terminal 9 of each personal computer is connected respectively with the conventional keyboards 6, 7, 8. The video output terminal 11 can use, for example, a D-sub terminal or DVI terminal.

A projector 5 is provided with a video input terminal 22 which uses the D-sub terminal or DVI terminal. Video input terminals 12 are connected to respective video output terminals 11. The status signal detecting units 13, 14, 15 are connected to the external keyboard input terminals 10 of the personal computers 2, 3, 4. The selected video output terminal 21 is connected with the video input terminal 22 of the projector 5.

The status signal detecting units 13, 14, 15 detect the keyboard control signals transmitted from the personal computers 2, 3, 4.

The switching control unit 16 reads the output switching program stored in the program storage unit 17 to the program processing unit 18, processes the detection result of the status signal detecting units 13, 14, 15 with the program processing unit 18 and determines the video output to be outputted to the projector from those of the personal computers 2, 3, 4.

The switching storage unit 19 stores the switching control program and the switching condition of the output switching device 1.

The video signal selecting unit 20 receives the video outputs of the personal computers 2, 3, 4 via the video input terminal 12, and outputs an input of the video input terminal corresponding to the video output determined with the switching control unit 16 to the selected video output terminal 21.

In the present invention, when a plurality of keyboards are connected to a personal computer, it is considered that the operating system such as Windows® recognizes the input modes of three keys of the CapsLock, ScrollLock, NumLock as the same mode in all keyboards.

When the three keys of CapsLock, ScrollLock, NumLock as the input mode switching keys are inputted with a certain keyboard, the personal computers respectively transmit the status signal to change the input mode to all keyboards in compliance with the request of the three keys of CapsLock, ScrollLock and NumLock. Accordingly, the identical input mode is recognized in all keyboards.

The signals for respective keys are referred to as the “CapsLock status signal,” the “ScrollLock status signal,” and the “NumLock status signal.”

Moreover, the input mode of the keyboard which is changed with input of the CapsLock, ScrollLock and NumLock keys is referred to respectively as the “CapsLock status,” the “ScrollLock status,” and the “NumLock status.”

The output switching device of the present invention is connected to the personal computer together with the keyboard to receive the status signal transmitted from the personal computer.

Operations of the output switching-device to which the status signal is transmitted to the personal computer will now be described.

When a presenter requests to display the video signal of a personal computer 2 by operating this personal computer, the presenter continuously inputs the CapsLock key of the keyboard 6. The personal computer 2 continuously transmits the CapsLock status signal to the keyboard 6 and also continuously transmits the CapsLock status signal to the status signal detecting unit 12 which is recognized with the personal computer 2 as the similar keyboard.

Here, “continuous transmission” means the transmission of two times of the status signal within a second from any key selected from the CapsLock, ScrollLock and NumLock keys.

When the status signal detection unit 13 receives continuously the CapsLock status signal, the switching control unit 16 reads the output switching program stored in the program storage unit 17 and performs the process to determine the output of the video output of the personal computer 2 to the projector 5 with the program processing unit 18.

The switching storage unit 19 stores the switching condition of the output switching device 1.

The video signal selecting unit 20 outputs the video output of the personal computer 2 determined with the switching control unit 16 to the selected video output terminal 21.

In the present invention, an input request is issued when the status signal detecting units 13, 14, 15 have continuously received the status signal.

Since the three keys CapsLock, ScrollLock, NumLock as the input switching keys are used for changing the input mode, when the output switching device 1 switches the video signal whenever the status signal is received, a problem occurs in the input operation of the personal computer. Therefore, only when the output switching device 1 has continuously received the same status signal (namely, only when the same input mode is selected continuously) is the video signal switched. Accordingly, a user is capable of using the input mode switching key for the operation of the output switching device 1 while it is also used for the conventional switching of input mode. Moreover, when the information apparatus switching device 1 switches the video signal when the status signal is received for several times, the input mode is set to the same condition as the switching operation after the user's switching operation, and thereby, a user can continuously perform the input operation.

As described above, the particular information can be selected from respective information pieces of a plurality of personal computers 2, 3, 4 with the operations therefrom.

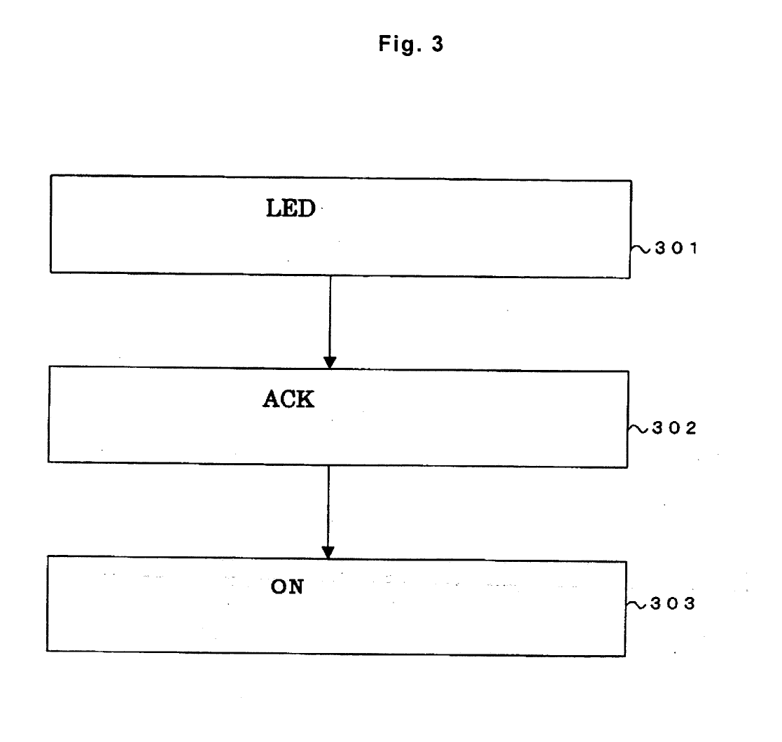

When the status signal is transmitted to a particular keyboard with the personal computers 2, 3, 4 connected with a plurality of keyboards which are used for the switching control of the personal computers 2, 3, 4 in the present invention, the status signal is also transmitted to the other keyboards as illustrated practically in FIG. 3.

FIG. 3 illustrates the flowchart of a keyboard in which the CapsLock key is inputted under the condition that a plurality of keyboards are connected and the CapsLock status turns to ON from OFF.

Here, when the CapsLock status is ON, it is assumed that Letters are displayed capitalized when Letters are input from the keyboard.

When the CapsLock key is inputted first, the keyboard receives, from the personal computer, an LED signal which is a sign to prepare for lighting of a light emitting diode or “LED” (step 301).

When the keyboard is capable of changing the CapsLock status, the ACK signal is transmitted to the personal computer as the OK sign (step 302).

When the ACK signal is transmitted to the personal computer from the keyboard, the keyboard then receives the CapsLock status signal. Accordingly, the CapsLock status is changed to ON from OFF (step 303).

Usually, a personal computer connected to a plurality of keyboards can recognize only one keyboard. Therefore, when the three keys CapsLock, ScrollLock, NumLock are inputted from a certain keyboard, if the keyboard status is changed, the personal computer transmits the status signal as the command for status change to all keyboards connected.

For example, when the CapsLock key is inputted and the status is changed to the capital letter or upper case input from small letter or lower case input with letter input, all letter inputs of all keyboards can be changed to the status of capital letter input.

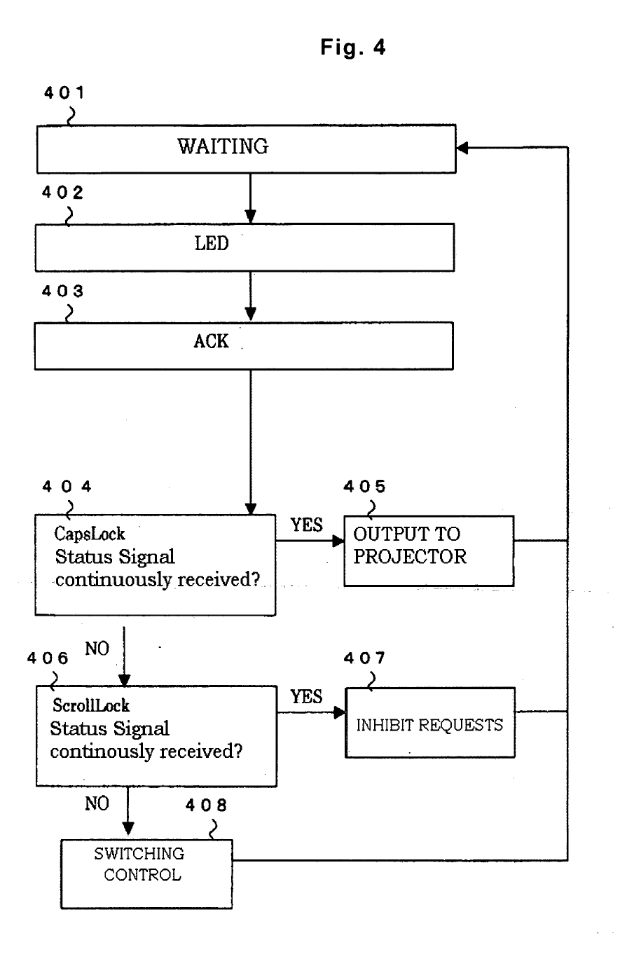

FIG. 4 illustrates a flowchart in which the status signal detecting units 13, 14, 15 within the output switching device 1 receive the status signals from the personal computers 2, 3, 4.

The status signal detecting units 13, 14, 15 are waiting to receive the status signals from the personal computers 2, 3, 4 (step 401). In other words, at step 401, the status signal monitoring unit is in the waiting condition.

A presenter, when he wants to switch the signal to the information signal of the particular personal computer, inputs the CapsLock key of the keyboard connected to the particular personal computer. The status signal detecting unit receives, at this time, the LED signal which is a sign to prepare for lighting a light emitting diode (LED) from the personal computer (step 402). Thus, step 402 represents reception of the LED signal.

When change of the CapsLock status is possible, the status signal detecting unit transmits the ACK signal to the personal computer as the OK sign (step 403). Thus, step 403 represents transmission of the ACK signal.

Upon reception of the ACK signal, the personal computer transmits the CapsLock status signal to the output switching device 1.

Here, when the CapsLock status signal is continuously received (step 404), the status signal detecting unit sends a request to the switching control unit 16 to output, to the projector 5, the video signal of the personal computer which has continuously received the CapsLock status signal (step 405). Thus, step 405 represents a connection request to the switching control unit.

Moreover, when the ScrollLock status signal is received continuously (step 406), the status signal detecting unit sends a switching inhibit request, to the switching control unit, in order to inhibit the requests from the other personal computers (step 407).

Moreover, the status signal detecting unit does not execute the switching control (step 408) when both CapsLock status signal and ScrollLock status signal are not received continuously and then returns to the waiting condition of the step 401. Thus, step 408 represents cancellation of command in relation to the status signal.

For example, when the CapsLock status signal or the like is received once and when the NumLock status signal is received, the switching control is not executed.

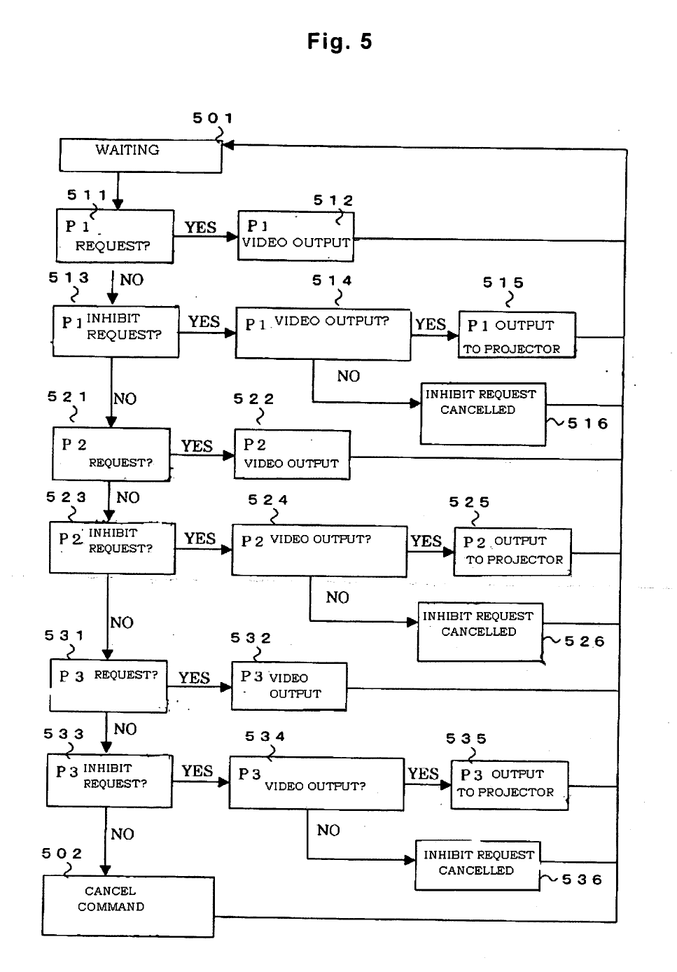

Next, FIG. 5 illustrates a flowchart of the output switching program in the switching control unit provided within the output switching device when three personal computers are connected to the output switching device.

In FIG. 5, P1, P2, P3 respectively indicate personal computers 2, 3, 4. As the initial condition, no signal is outputted to the projector 5.

First, the switching control unit 16 is in the condition of waiting for a request, switching inhibit request from the status signal detecting units 13, 14, 15 (step 501). In other words, at step 501 the switching control unit is in the waiting condition.

When the personal computer 2 sends a request to the switching control unit 16 (step 511), the switching control unit 16 issues an instruction for selecting the video signal of the personal computer 2 to the video signal selecting unit 20 and outputs the video signal of the personal computer 2 with the projector 5 (step 512). At this time, the switching storage unit 19 of the switching control unit 16 stores that an output is changed to that of the personal computer 2.

When the switching inhibit request is issued to the switching control unit 16 from the personal computer 2 (step 513), the switching control unit 16 determines by monitoring the switching storage unit 19 whether the video signal selecting unit 20 outputs the video signal of the personal computer 2 or not (step 514).

When the video signal of the personal computer 2 is outputted, an output to the projector 5 from the video signal of the personal computer 2 is fixed (step 515). If the video signal of the personal computer 2 is not outputted, the switching inhibit request is never executed (step 516). In other words, at step 516 the switching inhibit request command is cancelled.

Similarly, when the personal computer 3 sends a request to the switching control unit 16 (step 521), the switching control unit 16 sends an instruction for selecting the video signal of the personal computer 3 to the video signal selecting unit 20, and outputs the video signal of the personal computer 3 with the projector 5 (step 522). At this time, the switching storage unit 19 of the switching control unit stores that an output is switched to the output of the personal computer 3.

When the personal computer 3 sends a switching inhibit request to the switching control unit 16 (step 523), the switching control unit 16 determines by monitoring the switching storage unit 19 whether the video signal selecting unit 20 outputs the video signal of the personal computer 3 to the projector 5 or not (step 524).

When the video signal of the personal computer 3 is outputted, an output to the projector 5 from the video signal of the personal computer 3 is fixed (step 525). If the video signal of the personal computer 3 is not outputted, the switching inhibit request is not executed (step 526).

Similarly, the personal computer 4 sends a request to the switching control unit 16 (step 531), the switching control unit 16 issues an instruction to select the video signal of the personal computer 4 to the video signal selecting unit 20 and outputs the video signal of the personal computer 4 with the projector 5 (step 532). In this case, the switching storage unit 19 of the switching control unit stores that an output is switched to the output of the personal computer 4.

When the switching inhibit request is sent to the switching control unit 16 from the personal computer 4 (step 533), the switching control unit 16 determines by monitoring the switching storage unit 19 whether the video signal selecting unit 20 outputs or not the video signal of the personal computer 4 to the projector 5 (step 534).

When the video signal of the personal computer 4 is outputted, an output to the projector 5 from the video signal of the personal computer 4 is fixed (step 535). If the video signal of the personal computer 4 is not outputted, the switching inhibit request is not executed (step 536).

When no request and switching inhibit request is issued from any personal computer, the switching control unit 16 cancels the command in relation to the status signal (step 502) and returns to the step 501 waiting for the signal from the status signal detecting units 13, 14, 15.

Next, modification examples and other extended technical profiles of the preferred embodiment of the output switching device in the present invention will be described below.

In above embodiment, personal computers have been used as an example of information apparatus, but the present invention can also be applied to mobile telephones, personal hand phone systems, personal digital assistants, and notebook size personal computers. The present invention is not limited to personal computers, but could include any device with computing capabilities.

In the described embodiments, a request is sent to the switching control unit using the CapsLock key, and a switching inhibit request is sent to the switching control unit using the ScrollLock key. However, it is also possible to send the switching inhibit request using the NumLock key, and the switching inhibit request may be assigned to the desired two keys among the three keys CapsLock, ScrollLock and NumLock.

Moreover, the request, such as the switching inhibit request, may also be sent through the combination of the three keys CapsLock, ScrollLock, NumLock and other keys.

Moreover, if a new key for transmitting the signal to the information apparatus operating unit such as three keys CapsLock, ScrollLock and NumLock will be provided in future, the output switching device may be controlled using such newly provided key.

In above embodiment, three personal computers and the output switching device are connected, but the number of units of the personal computer is not limited only to three. Thus a greater or lesser number of personal computers, or a greater or lesser number of other information apparatuses may also be connected to the output switching device.

In the above embodiment, the video signal is described, for example, as the information inputted to the output switching device from the information apparatus. However, the present invention can also be applied to visual information and is not limited to video signals.

In the above embodiment, a PS/2 connector, external keyboard input terminal are described, for example, as the terminals for connecting the personal computers and the output switching device. However, if the information apparatus terminal and new terminal will be provided in future as the standard facility, such terminals may also be used.

In the above embodiment, the request, such as the switching inhibit request, is transmitted to the switching control unit when the CapsLock key and ScrollLock key are received continuously. “Continuous reception” means twice inputs of respective key within one second. However, the input period is not limited to one second and the number of times of input is also not limited to twice.

Since the input key has the effective function for switching the information apparatus operating unit, when such key is inputted, the input mode of the information apparatus operating unit is changed and this input mode is returned to the initial input mode. Therefore, such input key is usually inputted for an even number of times. However, change of the input mode can be eliminated, and the number of times of input is not limited to an even number times.

By using the present invention, two units of PCs can be used through the switching operation with one set of a display, keyboard and mouse. Moreover, USB peripheral devices may be connected using the six USB connectors provided. Accordingly, two units of PCs can be simply switched using a select switch. Since the USB6 port is mounted, six USB peripheral devices may be provided in common. Switching maybe accomplished using a hot key from the USB keyboard.

1. An output switching device for providing an output by selecting an input from a plurality of information apparatuses, comprising:
a detecting unit operable to detect a change of each input mode of a plurality of said information apparatuses;
a selecting unit operable to select an input from an information apparatus in which a change in input mode is detected with said detecting unit; and
an output unit operable to output the input selected with said selecting unit.

2. The output switching apparatus according to claim 1, wherein, when the output is changed to the output of the information apparatus in which the input mode is changed and when the input mode is changed to another input mode in said information apparatus, switching to another information apparatus is inhibited.

3. The output switching apparatus according to claim 1, wherein said detecting unit is further operable to detect an information apparatus in which an input mode is changed a plurality of times, and said selecting unit is further operable to select an output of the detected information apparatus in which the input mode is changed a plurality of times.

4. The output switching device according to claim 3, wherein the selecting unit is further operable to switch the output to an output of an information apparatus in which the input mode is changed an even number of times.

5. The output switching apparatus according to claim 1, wherein the detecting unit is further operable to detect input of a CapsLock key, a ScrollLock key, or a NumLock key of the information apparatus.

6. The output switching apparatus according to claim 1, further comprising a plurality of detecting units, each detecting unit operable to detect change in an input mode of an information apparatus.

7. An output switching display device for providing an output by switching an output of a plurality of information apparatuses, comprising:
a detecting unit operable to detect a plurality of information apparatuses and to notify an information apparatus in which an input mode is changed; and
a switching unit operable to select and switch an output of the notified information apparatus.

8. An output switching method for providing an output by selecting an input of a plurality of information apparatuses, comprising the steps of:
detecting change in each input mode of a plurality of said information apparatuses; and
selecting an input from an information apparatus in which change in input mode is detected.

9. A computer-readable storage medium storing the output switching program for providing an output by selecting an input of a plurality of information apparatuses, comprising:
means for detecting change in input mode of a plurality of said information apparatus; and
means for selecting an input from an information apparatus in which change in input mode is detected.

10. An output switching method in switching of the information apparatus for providing an output by switching an output of a plurality of information apparatuses, comprising:
detecting a plurality of information apparatuses;
notifying an information apparatus in which an input mode is changed; and
selecting and switching an output of said notified information apparatus.

11. A method of switching outputs from a plurality of personal computers to a single peripheral device, comprising:
detecting a status condition for each of the plurality of computing devices;
changing the status condition for each of the plurality of computing devices by operating a key of a keyboard associated with each of the plurality of computing devices; detecting the changed status condition; and
connecting the peripheral device to a computing device having the detected change of status.

12. A method according to claim 11, wherein the key is selected from the CapsLock Key, the ScrollLock Key and the NumLock Key, and operation of the Key includes operating the Key at least twice within a fixed period of time.

13. A method according to claim 11, wherein the key is selected from the CapsLock Key, the ScrollLock Key and the NumLock Key, and operation of the Key includes depressing the key for at least a fixed period of time.

14. An apparatus for selectively connecting an output from a plurality of first devices to an input of a second device, comprising:
means, for monitoring a connection status associated with each of the first devices;
means, connected to each of the first devices, for inputting a change in the connection status; and
means, responsive to the inputted change in the connection status, for connecting the output of a first device having a changed connection status to the second device.

15. An apparatus according to claim 14, wherein each of the first devices has a keyboard and inputting means including one of a CapsLock key, a ScrollLock key and a NumLock key.

16. An apparatus according to claim 15, wherein the inputting means include means for operating the key at least twice within a fixed period of time.

17. An apparatus according to claim 15, wherein inputting means includes means for depressing the key for a fixed period of time.

18. Apparatus according to claim 17, wherein the fixed period of time is one second.
